(19) United States
(12) Patent Application Publication
(10) Pub. No.: US 2004/0240194 A1
(43) Pub. Date: Dec. 2, 2004

(54) Back light unit

(76) Inventors: Jun-Hsian Lao, Chi-Lung City (TW); Cheng-Mou Li, Tao-Yuan City (TW)

Correspondence Address: NAIPO (NORTH AMERICA INTERNATIONAL PATENT OFFICE), P.O. BOX 506, MERRIFIELD, VA, 22116, US

(21) Appl. No.: 10/610,676

(22) Filed: Jul. 2, 2003

(30) Foreign Application Priority Data
May 28, 2003 (TW) 092114481

(51) Int. Cl. F21V 7/04

(52) U.S. Cl. 362/31

(57) ABSTRACT

A back light unit (BLU) disposed under a display panel has a light guide plate (LGP), and a light source generator for generating a light source disposed on a first side of the LGP. The LGP has a first reflecting film, which is coated on a bottom surface of the LGP, for reflecting the light source generated by the light source generator, and is utilized for scattering the reflected light source to the display panel through a top surface of the LGP.

### BACKGROUND OF THE INVENTION

1. Field of the Invention

The present invention relates to a back light unit (BLU), and more specifically, to a back light unit comprising a light guide plate (LGP) coated with a reflecting film.

2. Description of the Prior Art

Backlight units are known in the art. The backlight unit, which is a key element in the fabrication of liquid crystal displays, is widely used in digital cameras, PDAs, vehicle satellite navigation systems, computer monitors, flat panel TVs and so on. Typically, a backlight unit, which is generally installed underneath a display panel, comprises a light source (or multiple light sources) and a light diffusion means for providing users and consumers with diffused, ample, and comfortable backlighting. Light penetrates the overlying display panel and forms various images controlled by pixel electrodes densely arranged on the display panel. Backlight units are typically divided into two major categories: the edge light type and the direct-type, wherein the edge light type backlight unit occupies less space than the direct-type backlight does due to the design of the light source generator and is therefore more suited for small size electronic products.

Referring to FIG. 1, it is a cross-sectional view of a back light unit 10 according to the prior art. As shown in FIG. 1, the back light unit 10 is disposed under a display panel 11 and comprises a light guide plate (LGP) 12, a light source generator 14 disposed adjacent to a first surface of the light guide plate 12, a reflecting sheet 15 disposed under the light guide plate 12, a diffusing plate 16 disposed atop the light guide plate 12, at least one prism 18 disposed atop the diffusing plate 16, and a housing 20 disposed under the reflecting sheet 15 that surrounds the reflecting sheet 15 and the light source generator 14.

The light source generator 14 is utilized for generating a light source, and the reflecting sheet is utilized to upwardly reflect the light source generated by the light source generator 14 to the light guide plate 12. The light guide plate 12 is employed to upwardly scatter the light source to the diffusing plate 16, and comprises at least one patterned bump 22 for ensuring the light source to be evenly reflected. The reflecting sheet 15 is composed of silver, aluminum or a metal sheet with high reflectivity. The diffusing plate 16 is utilized to further scatter the light source to the display panel 11 through the prism 18, which is employed to reduce the difference of the luminous intensities on the display panel 11 in advance. Generally, the display panel 11 is a liquid crystal display panel (LCD panel), and the light source generator 14 is either a light emitting diode (LED) lamp or a cold cathode fluorescent lamp (CCFL).

However, as shown in FIG. 1, a space 24 with gas medium exists between the light guide plate 12 and the reflecting sheet 15, leading to an increased volume and complicated assembling processes of the back light unit 10. In addition, this gas medium leads to loss of the light source, reducing the light efficiency of the back light unit 10. Moreover, the reflecting sheet 15 frequently distorts under longtime operation of the back light unit 10. The uniformity of the reflecting sheet 15 is therefore reduced, making the intensity of the light source reflected by the reflecting sheet 15 to the display panel 11 uneven. The uneven intensity of the reflected light source is called “wave phenomenon” and results in a defective display quality of the display panel 11. Consequently, the product turns to be less competing in the market.

### SUMMARY OF THE INVENTION

It is therefore an object of the present invention to provide a back light unit with little gas medium inside to prevent wave phenomenon.

According to the present invention, the back light unit is disposed under a display panel. The back light unit comprises a light guide plate (LGP) with a first reflecting film coated on a bottom surface of the light guide plate, and a light source generator disposed adjacent to a first surface of the light guide plate. The light source generator is utilized for providing a light source, the first reflecting film is utilized for upwardly reflecting the light source, and the light guide plate is utilized for scattering the reflected light source through a top surface of the light guide plate to the display panel. In addition, the back light unit further comprises a diffusing plate disposed on the light guide plate, at least one prism disposed on the diffusing plate, and a housing disposed under the light guide plate for surrounding the light guide plate and the light source generator.

It is an advantage of the present invention against the prior art that the back light unit revealed in the present invention comprises the first reflecting film, coated on the bottom surface of the light guide plate, and a second reflecting film, coated on a second surface, a third surface and a fourth surface, utilized for the upward reflection of the light source generated by the light source generator. The reflecting sheet 15 shown in FIG. 1 can therefore neglected, further preventing wave phenomenon frequently occurred due to the distortion of the reflecting sheet 15 caused by longtime operation of the back light unit 10, as described in the section of “Description of the Prior Art”. In addition, no space exists between either the first reflecting film or second reflecting film and the light guide plate since the first and second reflecting films utilized for the reflection of the light source are coated on the light guide plate. Therefore, not only the loss of the light source caused by gas medium is prevented, leading to an improved light efficiency of the back light unit, but also the volume of the back light unit is reduced, making the product more easily portable. Moreover, the production cost is reduced due to the simplified manufacturing processes. As a result, the product turns to be much more competing in the market.

These and other objectives of the present invention will no doubt become obvious to those of ordinary skill in the art after reading the following detailed description of the preferred embodiment, which is illustrated in the multiple figures and drawings.

### BRIEF DESCRIPTION OF THE DRAWINGS

FIG. 1 is a cross-sectional view of a back light unit according to the prior art.

FIG. 2 is the cross-sectional view of a back light unit according to the present invention.

FIG. 3 is an enlarged schematic view of the light guide plate shown in FIG. 2.

FIG. 4 is a cross-sectional view of the light guide plate along the a-a axis shown in FIG. 3.

### DETAILED DESCRIPTION OF THE PREFERRED EMBODIMENT

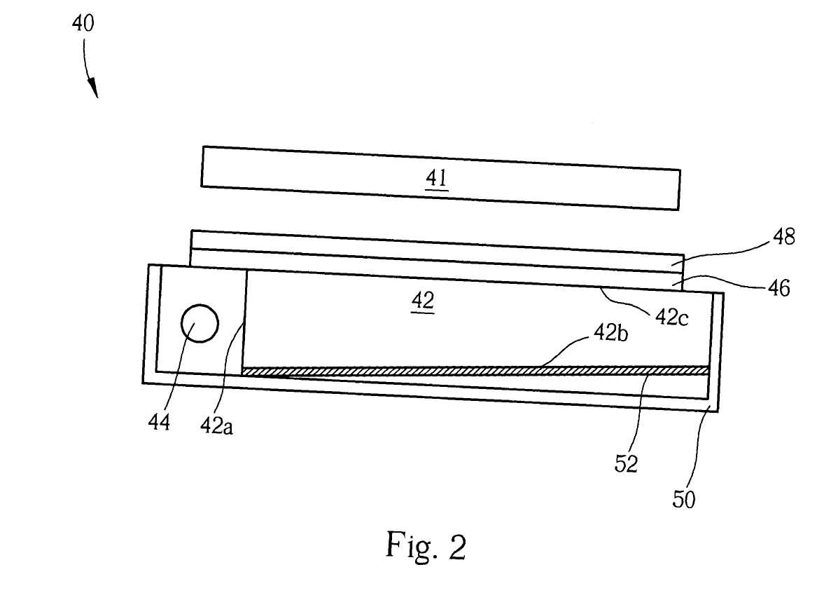

Referring to FIG. 2, it is a cross-sectional view of an edge light type back light unit 40 according to the present invention. As shown in FIG. 2, the back light unit 40 is disposed under a display panel 41 and comprises a light guide plate (LGP) 42, a light source generator 44 disposed adjacent to a first surface 42a of the light guide plate 42, a diffusing plate 46 disposed atop the light guide plate 42, at least one prism 48 disposed atop the diffusing plate 46, and a housing 50 disposed under the light guide plate 42 for surrounding the light guide plate 42 and the light source generator 44.

Generally, the light source generator 44 is a lamp for providing a light source, and the light guide plate 42 comprises a first reflecting film coated on a bottom surface 42b of the light guide plate 42 for upwardly reflecting the light source generated by the light source generator 44. The reflected light source is then further scattered through a top surface 42c of the light guide plate 42 to the diffusing plate 46, and is still further scattered to the display panel 41 from the diffusing plate 46 through the prism 48, which is employed to reduce the difference of the luminous intensities on the display panel 41 in advance. In the preferred embodiment of the present invention, the display panel 41 is a liquid crystal display panel (LCD panel), and the light source generator 44 is either a light emitting diode (LED) lamp or a cold cathode fluorescent lamp (CCFL). The first reflecting film 52 is composed of silver, aluminum or a metal sheet with high reflectivity, and the bottom surface 42b of the light guide plate 42 is a sloped surface not parallel with the top surface 42c of the light guide plate 42 employed to reinforce the reflection of the light source. In another embodiment of the present invention, the bottom surface 42b of the light guide plate 42 is alternatively a surface parallel with the top surface 42c of the light guide plate 42 for the purpose of reducing the volume of the back light unit 40, and is not shown in FIG. 2 for simplicity of description.

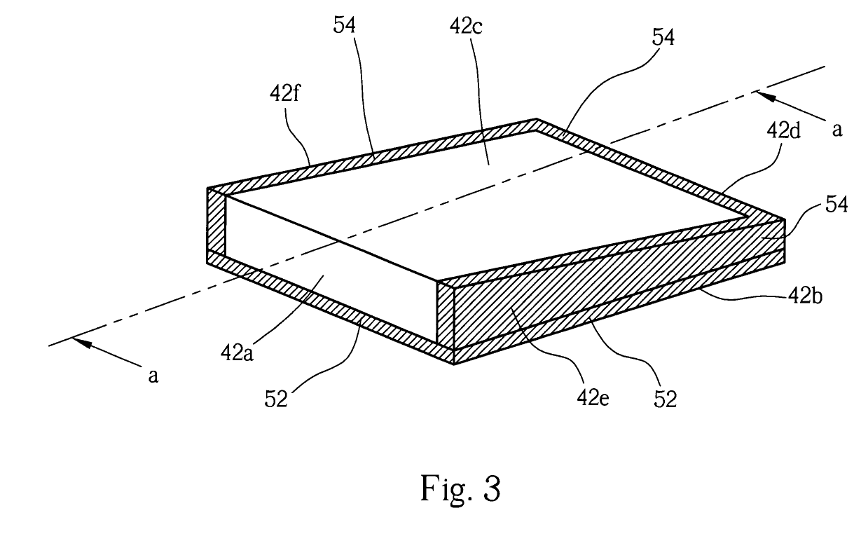

Referring to FIG. 3, it is an enlarged schematic view of the light guide plate 42 shown in FIG. 2. As shown in FIG. 3, optionally, the light guide plate 42 comprises a second reflecting film 54, composed of silver, aluminum or a metal sheet with high reflectivity, coated on a second surface 42d, a third surface 42e and a fourth surface 42f to reinforce the upward reflection of the light source generated by the light source generator 44 for product requirement of the back light unit 40, wherein the second surface 42d is on the opposite side of the first surface 42a, and both the third and fourth surfaces 42e and 42f are perpendicular to both the second surface 42d and the top surface 42c. However, since the light source is mainly reflected by the first reflecting film 52 coated on the bottom surface 42b, the second reflecting film 54 can be neglected or only coated on either one or two of the second surface 42d, third surface 42e and fourth surface 42f.

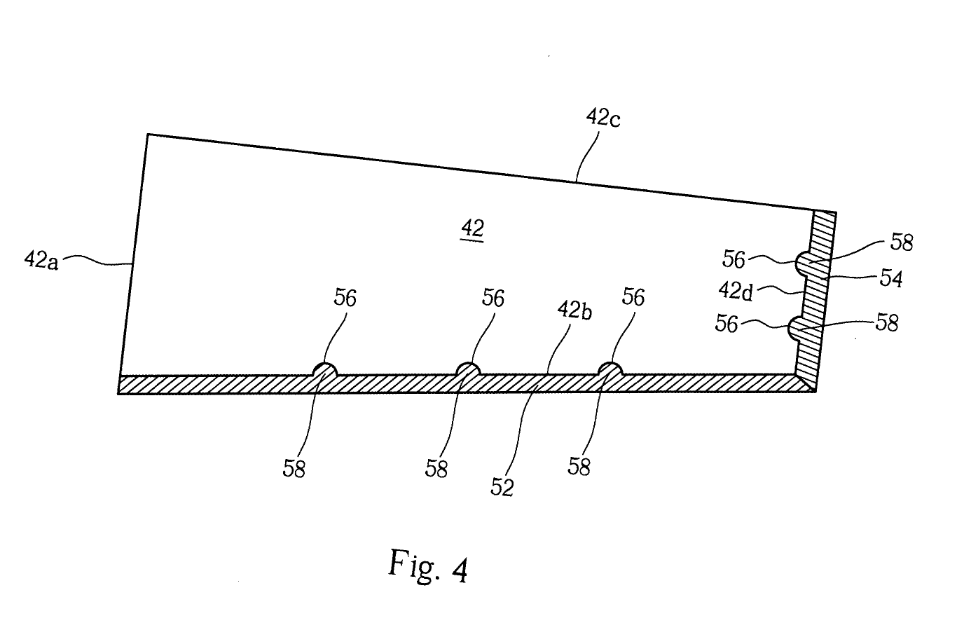

Referring to FIG. 4, it is a cross-sectional view of the light guide plate 42 along the a-a axis shown in FIG. 3. As shown in FIG. 4, each of the bottom surface 42b, coated with the first reflecting film 52, and the second surface 42d, the third surface 42e (not shown in FIG. 4) and the fourth surface 42f (not shown in FIG. 4), which are coated with the second reflecting film 54, comprises at least one pattern recess 56. Each recess 56 is filled by either the first reflecting film 52 or the second reflecting film 54 during the coating of either the first reflecting film 52 or the second reflecting film 54 to form a pattern bump 58. The light source can be adjusted by the bump 58, and is therefore more evenly reflected to the top surface 42c of the light guide plate 42 and further scattered to the display panel 41. Generally, both the recess 56 and the bump 58 have a semi-spherical shape. Alternatively, Generally, both the recess 56 and the bump 58 have a parallel or perpendicular double-V shape (not shown).

As previously mentioned, the bottom surface 42b of the light guide plate 42 is alternatively designed as a surface parallel with the top surface 42c of the light guide plate 42 for the purpose of reducing the volume of the back light unit 40. The detailed structure and function of the alternatively designed bottom surface 42b parallel with the top surface 42c of the light guide plate 42 are similar to those of the bottom surface 42b shown in FIG. 2 to FIG. 4, and is omitted for simplicity of description.

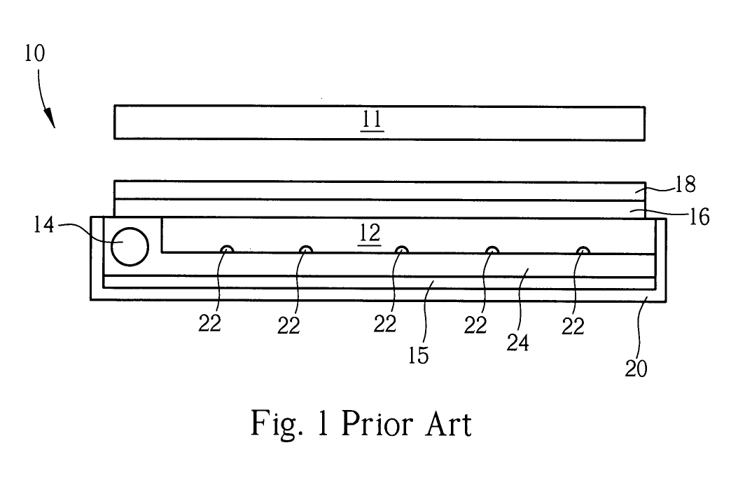

In comparison with the back light unit 10 according to the prior art shown in FIG. 1, the back light unit 40 revealed in the present invention comprises the first reflecting film 52, coated on the bottom surface 42b of the light guide plate 42, and the second reflecting film 54, coated on the second surface 42d, the third surface 42e and the fourth surface 42f, utilized for the upward reflection of the light source generated by the light source generator 44. The reflecting sheet 15 shown in FIG. 1 can therefore neglected, further preventing wave phenomenon frequently occurred due to the distortion of the reflecting sheet 15 caused by longtime operation of the back light unit 10, as described in the section of “Description of the Prior Art”. In addition, no space exists between either the first reflecting film 52 or second reflecting film 54 and the light guide plate 42 since the first and second reflecting films 52 and 54 utilized for the reflection of the light source are coated on the light guide plate 42. Therefore, not only the loss of the light source caused by gas medium is prevented, leading to an improved light efficiency of the back light unit 40, but also the volume of the back light unit 40 is reduced, making the product more easily portable. Moreover, the production cost is reduced due to the simplified manufacturing processes. As a result, the product turns to be much more competing in the market.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A back light unit disposed under a display panel comprising:
a light guide plate with a first reflecting film coated on a bottom surface of the light guide plate; and
a light source generator disposed adjacent to a first surface of the light guide plate;
wherein the reflecting film is employed to upwardly reflect a light source generated by the light source generator, and the light guide plate is employed to further scatter the reflected light source through a top surface of the light guide plate to the display panel.

2. The back light unit of claim 1, wherein the light guide plate comprises at least one second reflecting film coated on at least one of a second surface, a third surface and a fourth surface of the light guide plate for reflecting the light source generated by the light source generator.

3. The back light unit of claim 2, wherein the first and second reflecting film comprise silver (Ag) or aluminum (Al).

4. The back light unit of claim 1, wherein the bottom surface of the light guide plate comprises at least one patterned first recess.

5. The back light unit of claim 4, wherein the first reflecting film comprises at least one patterned first bump for filling the first recess.

6. The back light unit of claim 2, wherein the surface of the light guide plate coated with the second reflecting film comprises at least one pattern second recess.

7. The back light unit of claim 6, wherein the second reflecting film comprises at least one patterned second bump for filling the second recess.
